(19) United States
(12) Patent Application Publication
(10) Pub. No.: US 2006/0145610 A1
(43) Pub. Date: Jul. 6, 2006

(54) Plasma display panel and substrate

(75) Inventors: Syuma Eifuku, Miyazaki-shi (JP); Toshiyuki Nanto, Miyazaki-shi (JP); Nobuhiro Iwase, Miyazaki-shi (JP); Tetsurou Kawakita, Miyazaki-shi (JP)

Correspondence Address: STAAS & HALSEY LLP, SUITE 700, 1201 NEW YORK AVENUE, N.W., WASHINGTON, DC, 20005, US

(73) Assignee: FUJITSU HITACHI PLASMA DISPLAY LIMITED, Kawasaki (JP)

(21) Appl. No.: 11/262,939

(22) Filed: Nov. 1, 2005

(30) Foreign Application Priority Data
Nov. 5, 2004 (JP) 2004-322236

(51) Int. Cl. H01J 17/49

(52) U.S. Cl. 313/582

(57) ABSTRACT

A panel structure is provided in which a dielectric layer having no voids thereinside can be formed by a vapor deposition method. A layered film of plural metal layers that constitute an electrode covered with a dielectric layer is formed to have a stepped shape in which a width is smaller from a bottom layer to an uppermost layer for each layer in order. The stepped shape is formed by projecting an edge portion of a lower layer by design compared to an upper layer.

### BACKGROUND OF THE INVENTION

1. Field of the Invention

The present invention relates to plasma display panels and is characterized by structures of an electrode and a dielectric layer for covering the same.

2. Description of the Related Art

AC type plasma display panels have a dielectric layer covering display electrodes. Dielectric layers are generally made of low-melting glass and are formed by a thick film process in which low-melting glass paste is applied and burned.

Vapor deposition methods (also called vapor growth methods) have recently received attention as methods for forming dielectric layers. Japanese Unexamined Patent Publication No. 2000-21304 describes forming dielectric layers made of silicon dioxide or organic silicon oxide by the plasma CVD (Chemical Vapor Deposition) method that is one type of chemical vapor deposition methods. When the vapor deposition methods are used, it is possible to obtain thin dielectric layers having a uniform thickness and to form dielectric layers made of low dielectric constant materials that are advantageous to reduction in interelectrode capacitance at lower temperatures compared to a burning process.

Metal films of a three-layer structure of Cr—Cu—Cr are well known as a structure of display electrodes. Copper as an intermediate layer is a main conductor and chromium as a lower layer serves to enhance adhesion to a glass substrate or a transparent conductive film. Chromium as an upper layer serves to prevent a chemical reaction between low-melting glass that is a material of a dielectric and copper that is a material of an electrode.

Metal films having a three-layer structure are formed by laminating three layers on the entire screen using a film deposition method such as sputtering, and then by patterning the three layers all together. In the patterning, an etching mask having a predetermined pattern is formed by the photolithograph process and one etching mask thus formed is shared for etching of the three layers. Accordingly, the three layers are basically equal to one another in plane pattern and size. In other words, the three layers fully overlap with one another in usual cases.

Conventional plasma display panels have a drawback that a void is apt to be found in the vicinity of a plural-layered metal film that constitutes a display electrode when a vapor deposition method is used to form a dielectric layer. A void is generated, in patterning of a metal film, when an upper layer has a pattern width larger than a lower layer has. This is because, in an overhanging structure in which an edge portion of an upper layer projects over a lower layer, a void generated below the projecting edge portion does not deposit materials of a dielectric.

A void inside a dielectric layer causes dielectric breakdown or improper control of discharge. Influence due to a void increases with decreasing the thickness of the dielectric layer. This is because as the layer is thinner, the void is larger relative to the layer thickness. In addition, as a screen size increases, the difficulty of equalizing an etching amount in patterning of electrodes increases, causing excessive progress of side etching locally in many cases. As side etching progresses, a projection amount of an upper layer increases, so that a void gets larger.

The problem that a void is formed inside a dielectric layer arises also when a dielectric layer is formed by a thick film process. In particular, when a lamination method, which is one for attachment of a sheet-like material, is used to apply low-melting glass, air remains in an overhanging portion of a metal film in the attachment. Accordingly, a void is apt to be generated.

### SUMMARY OF THE INVENTION

The present invention is directed to solve the problem pointed out above, and therefore, an object of the present invention is to provide an electrode coating structure in which a void is less likely to be generated inside a dielectric layer. Another object of the present invention is to enhance practicability in formation of a dielectric layer using a vapor deposition method.

According to one aspect of the present invention, a layered film of plural metal layers that constitute an electrode covered with a dielectric layer is formed to have a stepped shape in which a width is smaller from a bottom layer to an uppermost layer for each layer in order. More specifically, compared to an upper layer, an edge portion of a lower layer is formed to project outward by design. This eliminates an eaves-shaped structure hindering deposition, so that no voids are generated inside a dielectric layer even when a chemical vapor deposition method or a physical vapor deposition method is used to form a dielectric layer.

According to the present invention, a void is less likely to be formed inside a dielectric layer, leading to increase in reliability of plasma display panels.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of a cell structure of a three-electrode surface discharge type plasma display panel.

FIG. 2 is a diagram showing a planar shape of a display electrode.

FIG. 3 is a diagram showing a cross-sectional structure in the arrow direction taken along the line a-a of FIG. 2.

FIG. 4 is a diagram showing a layered structure of the display electrode.

FIGS. 5A-5E schematically show a process of forming a metal film of the display electrode.

### DESCRIPTION OF THE PREFERRED EMBODIMENTS

The present invention can be suitably applied to three-electrode surface discharge type plasma display panels that are used as color display devices.

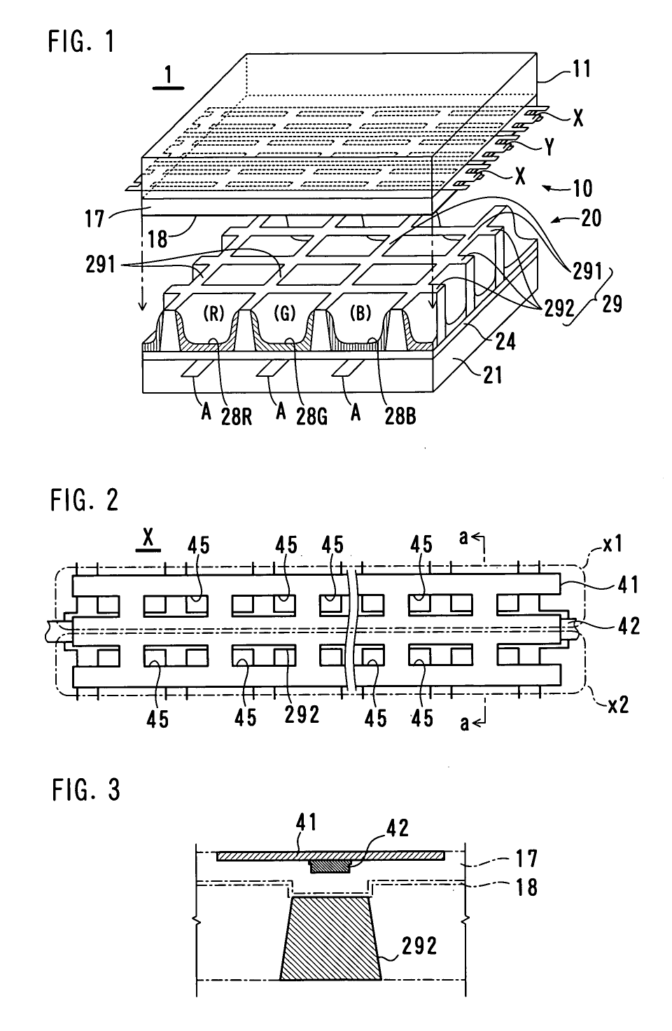

FIG. 1 is a diagram showing an example of a cell structure of a three-electrode surface discharge type plasma display panel. For easy understanding of an internal structure, FIG. 1 illustrates a part corresponding to 3×2 cells in a plasma display panel 1 with a front panel 10 being detached from a rear panel 20.

The plasma display panel 1 includes the front panel 10 and the rear panel 20. The front panel 10 and the rear panel 20 are structural elements of the plasma display panel 1. A base of each of the front panel 10 and the rear panel 20 is a glass sheet that is larger than the screen and has a thickness of approximately 3 mm. The front panel 10 corresponds to a substrate in the present invention. The front panel 10 includes a glass sheet 11, display electrodes X and Y as row electrodes, a dielectric layer 17 and a protection film 18. The display electrodes X and Y are covered with the dielectric layer 17 and the protection film 18. The rear panel 20 includes a glass sheet 21, address electrodes A as column electrodes, an insulation layer 24, a partition 29 as a mesh-patterned discharge barrier and fluorescent material layers 28R, 28G and 28B for color display. The partition 29 is a structure in which plural vertical walls 291 for defining columns in the screen are integral with plural horizontal walls 292 for defining rows in the screen. The fluorescent material layers 28R, 28G and 28B are excited by ultraviolet rays emitted from a discharge gas so as to emit light. Alphabet letters R, G and B in parentheses in FIG. 1 denote light emission colors of the fluorescent materials.

Each of the display electrodes X and Y includes a transparent conductive film 41 that is patterned to have a wide ribbon-like shape and a metal film 42 that is patterned to have a narrow ribbon-like shape. The metal film 42 is a bus conductor for reducing electrical resistance of an electrode. A set of a display electrode X and a display electrode Y that are adjacent to each other makes an electrode pair (an anode and a cathode) for a surface discharge. The display electrode X and the display electrode Y are equal to each other in structure.

FIG. 2 shows a planar shape of a display electrode and FIG. 3 shows a cross-sectional structure in the arrow direction taken along the line a-a of FIG. 2. The display electrode X is illustrated as a typical example in FIGS. 2 and 3.

The transparent conductive film 41 of each of the display electrodes X and Y has a ribbon-like shape in which plural rectangular holes 45 are provided on both sides of respective central parts of portions overlapping with the horizontal wall 292 and the rectangular holes 45 are spaced out along the horizontal wall 292. The metal film 42 has a straight ribbon-like shape with a constant width and overlaps with a middle portion of the transparent conductive film 41. Two of ladder portions x1 and x2, which are obtained by dividing the display electrode X into two parts in the column direction, are respectively engaged in display of one row.

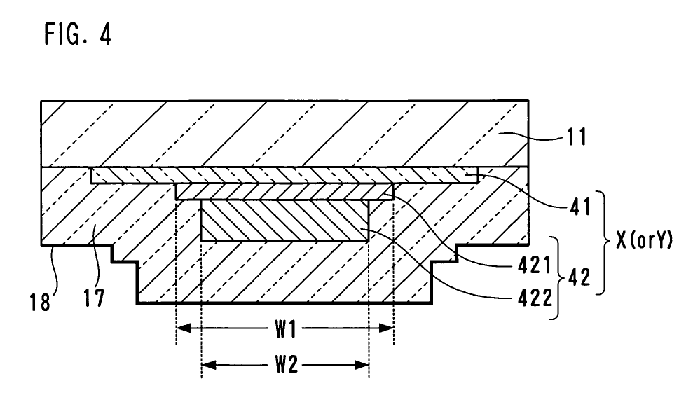

FIG. 4 shows a layered structure of a display electrode. The reference character X (or Y) in the drawing indicates that a structure including relevant elements is a common structure to the display electrode X and the display electrode Y.

As described above, each of the display electrode X and the display electrode Y includes the ribbon-like transparent conductive film 41 and the metal film 42 having a width smaller than the transparent conductive film 41 has. The transparent conductive film 41 includes tin oxide as a main constituent and is a single-layer film having a thickness of approximately 5000 Å. The metal film 42 is a layered film having a two-layer structure in which a main conductor layer 422 overlaps with a base layer 421. The base layer 421 is made of chromium (Cr) and has a thickness of approximately 500 Å. The main conductor layer 422 is made of copper (Cu) and has a thickness of approximately 3 μm.

Note that materials of the electrodes are not limited to the exemplified materials. Materials that are suitable for the main conductor layer 422 and are superior in electrical conductivity include, for example, silver (Ag) and aluminum (Al). Materials of the base layer 421 that enhance adhesion to the main conductor layer 422 include molybdenum (Mo), tungsten (W), nickel (Ni) and titanium (Ti).

The layered structure in each of the display electrodes X and Y is characterized in that the metal film 42 is formed to have a stepped shape in which a width is smaller from a lower layer to an upper layer for each layer in order. More specifically, in the metal film 42, the main conductor layer 422 as an upper layer of a layered film has a width W2 smaller than a width W1 of the base layer 421 as a lower layer, and both ends of the base layer 421 project outward beyond the main conductor layer 422 respectively. The projection length of the base layer 421 is preferably a value ranging from approximately 1 to 10 μm and such a value is sufficiently smaller than a typical value of each of the widths W1 and W2, i.e., a value ranging from 50 to 80 μm.

A low dielectric constant material is desirable for a material of the dielectric layer 17 covering the display electrode X. In particular, silicon dioxide (SiO₂) is preferable for a material of the dielectric layer 17. Even if silicon dioxide contacts copper, no significant chemical reactions take place. Accordingly, it is unnecessary to form the metal film 42 in the form of three-layer structure by forming an anti-reaction layer on the main conductor layer 422 made of copper. The small number of layers contributes to reduction in the cost of production.

The dielectric layer 17 made of silicon dioxide is formed by the plasma CVD method. Since the plasma CVD method is one for depositing materials on a formation surface in the same direction, a surface layer of the dielectric layer 17 has steps reflecting irregularities on the formation surface. In forming the dielectric layer 17, a technique for producing compressive stress, which is disclosed in Japanese Unexamined Patent Publication No. 2000-21304, is adopted to prevent cracking.

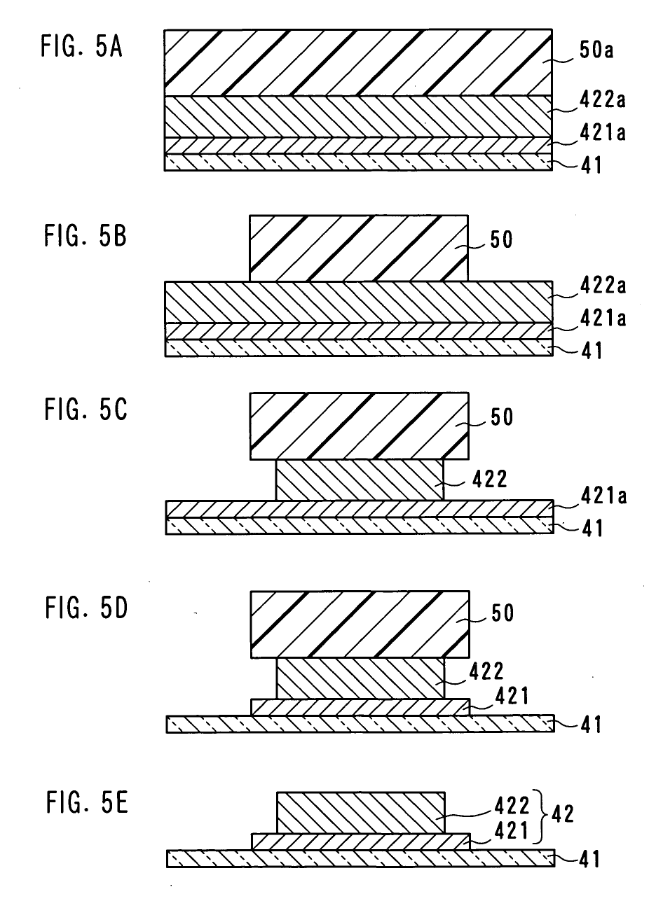

FIGS. 5A-5E schematically show a process of forming a metal film of a display electrode.

As shown in FIG. 5A, chromium that is a material of a base layer and copper that is a material of a main conductor layer are formed on the patterned transparent conductive film 41 in order of mention by sputtering, so that two layers 421a and 422a are formed. Then, a resist film 50a for patterning is overlaid on the film 422a. The resist film 50a is patterned by photolithography. Then, as shown in FIG. 5B, a resist mask 50 is formed which has a pattern of covering portions corresponding to the metal film 42 in the layers 421a and 422a. On this occasion, allowing for a side etching amount that is described later, it is necessary to optimize a pattern width of the resist mask 50.

A first etchant that dissolves copper selectively is used to remove portions that are not masked in the layer 422a (see FIG. 5C). For example, ferric chloride is used as the first etchant. When the layer 422a is etched, etching time is controlled to progress side etching intentionally, so that a main conductor layer 422 is formed which has a pattern width substantially smaller than that of the resist mask 50. After that, the process goes to a patterning step of the layer 421a with the resist mask 50 remaining.

A second etchant that dissolves chromium selectively is used to pattern the layer 421a. For example, hydrochloric acid is suitable for the second etchant. At the starting point of patterning, since the pattern width of the main conductor layer 422 that is already formed is smaller than that of the resist mask 50 as described above, there is a void between the layer 421a to be etched and the resist mask 50. An etching rate in this void is, however, substantially lower compared to an etching rate in a non-masked area that is not covered with the resist mask 50, because the main conductor layer 422 has a thickness of a few microns in practice. Accordingly, non-masked portions of the layer 421a are removed practically, so that a base layer 421 is formed which has a pattern width larger than that of the main conductor layer 422 as shown in FIG. 5D. The layer 421a is patterned and after that the resist mask 50 is removed. Thus, formation of a display electrode is completed (see FIG. 5E).

In the process discussed above, one resist mask 50 is used to form the base layer 421 and the main conductor layer 422 both of which have different pattern widths. Accordingly, the above-described process needs less man-hour in comparison with a case where resist masks are used individually for the base layer 421 and the main conductor layer 422. It is noted that if anisotropic dry etching is adopted for patterning of the layer 421a, it is possible to form a base layer 421 reliably whose edge projects outward beyond the main conductor layer 422.

The present invention is useful for improvement in reliability of AC type plasma display panels that include an electrode having at least two metal layers and a dielectric layer covering the electrode.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A plasma display panel comprising:
a metal film having a plural-layer structure; and
a dielectric layer for covering the metal film,
wherein the metal film is formed to have a stepped shape in which a width is smaller from a bottom layer to an uppermost layer for each layer in order.

2. The plasma display panel according to claim 1, wherein the dielectric layer is formed by a vapor deposition method.

3. A plasma display panel comprising:
an electrode including a transparent conductive film and a metal film having a plural-layer structure; and
a dielectric layer for covering the electrode,
wherein
the metal film is formed to have a stepped shape in which a width is smaller from a bottom layer to an uppermost layer for each layer in order, and
the dielectric layer is formed by a vapor deposition method.

4. A plasma display panel comprising:
a display electrode including a transparent conductive film and a metal film; and
a dielectric layer for covering the display electrode,
wherein
the metal film includes a base layer that contacts the transparent conductive film and a main conductor layer that has electrical resistance lower than the base layer has,
the metal film is formed to have a stepped shape in which an edge of the base layer projects outward beyond an edge of the main conductor layer, and
the dielectric layer is formed by a vapor deposition method.

5. A plasma display panel comprising:
a display electrode including a transparent conductive film and a metal film; and
a dielectric layer for covering the display electrode,
wherein
the metal film includes a chromium layer that contacts the transparent conductive film and a copper layer that is overlaid on the chromium layer,
the metal film is formed to have a stepped shape in which an edge of the chromium layer projects outward beyond an edge of the copper layer, and
the dielectric layer is made of silicon dioxide.

6. A substrate for use in a plasma display panel that includes a metal film having a plural-layer structure and a dielectric layer for covering the metal film, wherein
the metal film is formed to have a stepped shape in which a width is smaller from a bottom layer to an uppermost layer for each layer in order.

7. The substrate according to claim 6, wherein the dielectric layer is formed by a vapor deposition method.

8. A substrate for use in a plasma display panel that includes an electrode having a transparent conductive film and a metal film having a plural-layer structure and includes a dielectric layer for covering the electrode,
wherein
the metal film is formed to have a stepped shape in which a width is smaller from a bottom layer to an uppermost layer for each layer in order, and
the dielectric layer is formed by a vapor deposition method.

9. A substrate for use in a plasma display panel that includes a display electrode having a transparent conductive film and a metal film and includes a dielectric layer for covering the display electrode,
wherein
the metal film includes a base layer that contacts the transparent conductive film and a main conductor layer that has electrical resistance lower than the base layer has,
the metal film is formed to have a stepped shape in which an edge of the base layer projects outward beyond an edge of the main conductor layer, and
the dielectric layer is formed by a vapor deposition method.

10. A substrate for use in a plasma display panel that includes a display electrode having a transparent conductive film and a metal film and includes a dielectric layer for covering the display electrode,
wherein
the metal film includes a chromium layer that contacts the transparent conductive film and a copper layer that is overlaid on the chromium layer,
the metal film is formed to have a stepped shape in which an edge of the chromium layer projects outward beyond an edge of the copper layer, and
the dielectric layer is made of silicon dioxide.
